(19) United States
(12) Patent Application Publication
(10) Pub. No.: US 2025/0023101 A1
(43) Pub. Date: Jan. 16, 2025

(54) ELECTROLYTE SOLUTION AND BATTERY

(71) Applicant: ZHUHAI COSMX BATTERY CO., LTD., Zhuhai (CN)

(72) Inventors: Yaming QIU, Zhuhai (CN); Hai WANG, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/898,160

(22) Filed: Sep. 26, 2024

Related U.S. Application Data
(63) Continuation-in-part of application No. PCT/CN2023/098200, filed on Jun. 5, 2023.

(30) Foreign Application Priority Data
Sep. 30, 2022 (CN) 202211218101.7

(51) Int. Cl. H01M 10/0567; H01M 10/0525; H01M 10/054; H01M 10/0568; H01M 10/0569

(52) U.S. Cl. CPC H01M 10/0567; H01M 10/0525; H01M 10/054; H01M 10/0568; H01M 10/0569; H01M 2300/0028; H01M 2300/0051

(57) ABSTRACT

Disclosed are an electrolyte solution and a battery including the electrolyte solution. The electrolyte solution includes an organic solvent, an electrolyte salt, and an additive A; and the additive A is a selenocyanate salt. In the present disclosure, the following effects are achieved by oxidatively decomposing an electrolyte additive at a positive electrode to form a CEI film that has a high strength and is rich in inorganic matter: oxidative decomposition side reactions of the electrolyte solution are greatly reduced; and a loss of a positive electrode active material at a high temperature and a high pressure is decreased. Therefore, performance of a battery at a high temperature and a high pressure is improved, and cycling stability and high-temperature stability of the battery are improved.

### CROSS-REFERENCE TO RELATED APPLICATIONS

The present disclosure is a continuation-in-part of International Application No. PCT/CN2023/098200, filed on Jun. 5, 2023, which claims priority to Chinese Patent Application No. 202211218101.7, filed on Sep. 30, 2022. Both of the aforementioned applications are hereby incorporated by reference in their entireties.

### TECHNICAL FIELD

The present disclosure relates to the field of battery technologies, and specifically, to an electrolyte solution and a battery including the electrolyte solution.

### BACKGROUND

A lithium-ion battery is an indispensable part in various application fields such as electronic products, electric vehicles, and energy storage apparatuses. Compared with other energy storage methods, lithium-ion batteries have irreplaceable advantages such as high energy density and long cycle life. With the rapid development of science and technologies, a lithium-ion battery needs to have an increasingly high energy density. Improving a voltage of the lithium-ion battery is one of most important ways to improve the energy density.

Currently, voltages of most of commercialized consumer lithium-ion batteries are 4.45 V or lower, and voltages of a few products have reached 4.48 V. A voltage of a next-generation lithium-ion battery needs to be further increased to 4.5 V or above. At a higher voltage, it is easier for a commercialized electrolyte solution using a carbonate or a carboxylate as a main solvent to be oxidatively decomposed. As a result, it is more difficult for a battery using the electrolyte solution to satisfy commercial requirements for high-temperature cycling performance and high-temperature storage performance. To achieve extensive commercial application of lithium-ion batteries whose voltages are 4.5 V or above, novel effective electrolyte additives need to be developed to improve cycling stability and high-temperature performance of the high-voltage lithium-ion batteries, thereby realizing large-scale commercialization of 4.5 V high-energy-density batteries.

Therefore, it is of great practical significance to develop an electrolyte solution that can improve cycling performance and high-temperature performance of a high-voltage lithium-ion battery having a voltage of 4.5 V or above and can reduce oxidative decomposition of the electrolyte solution on a positive electrode side.

### SUMMARY

In view of this, the present disclosure provides an electrolyte solution and a battery including the electrolyte solution. In the present disclosure, the following effects may be achieved by oxidatively decomposing an electrolyte additive at a positive electrode to form a CEI (positive electrode electrolyte solution interface, that is Chemical-Electrochemical Interface) film that has a high strength and is rich in inorganic matter: oxidative decomposition side reactions of the electrolyte solution are greatly reduced; and a loss of a positive electrode active material at a high temperature and a high pressure is decreased. Therefore, performance of a battery at a high temperature and a high pressure is improved, and cycling stability and high-temperature stability of the battery are improved.

To achieve the foregoing objectives of the present disclosure, the present disclosure provides the following technical solutions.

The present disclosure provides an electrolyte solution. The electrolyte solution includes an organic solvent, an electrolyte salt, and an additive A; and the additive A is a selenocyanate salt.

Compared with the prior art, the present disclosure has the following beneficial effects.

In the electrolyte solution provided in the present disclosure and the battery including the electrolyte solution, a CEI film having a high strength and being rich in inorganic matter may be formed by oxidatively decomposing an additive A (a selenocyanate salt) at a positive electrode. In this way, oxidative decomposition side reactions of the electrolyte solution are greatly reduced; and a loss of a positive electrode active material of the battery under a high-temperature condition is decreased. Therefore, stability of the battery is improved; and high-temperature and high-pressure performance of the battery is significantly improved.

### DETAILED DESCRIPTION OF THE EMBODIMENTS

Specific implementations of the present disclosure are described below in detail. It should be understood that the specific implementations described herein are merely intended to illustrate and explain the present disclosure rather than to limit the present disclosure.

The present disclosure provides an electrolyte solution. The electrolyte solution includes an organic solvent, an electrolyte salt, and an additive A; and the additive A is a selenocyanate salt.

The additive A (the selenocyanate salt) in the electrolyte solution provided in the present disclosure may be oxidatively decomposed at a positive electrode to form a CEI film that has a high strength and is rich in inorganic matter, so that oxidative decomposition side reactions of the electrolyte solution are greatly reduced; and a loss of a positive electrode active material under a high-temperature condition is decreased. This is beneficial for improving stability and high-temperature and high-pressure performance of the battery.

Preferably, the selenocyanate salt is selected from at least one of potassium selenocyanate (KSeCN), sodium selenocyanate (NaSeCN), or lithium selenocyanate (LiSeCN). What works in the selenocyanate salt is a selenocyanato group. The selenocyanato group may be oxidatively decomposed at the positive electrode to form the CEI film, thereby improving stability of the battery. In a specific embodiment of the present disclosure, the selenocyanate salt is potassium selenocyanate, but another selenocyanate salt (for example, sodium selenocyanate or lithium selenocyanate) may also play a role of forming a CEI film.

Under a high-voltage condition, the electrolyte solution needs to face strong oxidation of high-valence transition metal on a surface of the positive electrode; and a high temperature obviously enhances a strength of the strong oxidation. Currently, in addition to manners such as coating and/or doping a positive electrode active material, oxidatively decomposing an electrolyte solution at a positive electrode may also be improved by adding a film forming additive into the electrolyte solution. In this way, a passivation protective film is formed on the surface of the positive electrode to reduce direct contact between the electrolyte solution and the positive electrode active material, but an improvement effect is insignificant. Inventors of the present disclosure find that a passivation film that is even and has a relatively high mechanical strength may be formed by adding the additive A; and direct contact between the electrolyte solution and the transition metal can be further reduced by adding some materials that can coordinate with the transition metal, thereby further reducing a risk of side reactions. Further, the passivation film formed by the additive A may enhance coordination between a specific material and the transition metal, thereby further reducing side reactions.

Preferably, the electrolyte solution further includes an additive B; and the additive B is a trinitrile compound.

When the electrolyte solution provided in the present disclosure includes the additive A and the additive B, the additive A (the selenocyanate salt) is oxidatively decomposed at the positive electrode to form a CEI film that has a high strength and is rich in inorganic matter, and the additive B (the trinitrile compound) coordinates with the transition metal, so that oxidative decomposition side reactions of the electrolyte solution are greatly reduced; and a loss of a positive electrode active material under a high-temperature condition is decreased. Therefore, stability of the battery is improved; and high-temperature and high-pressure performance of the battery is significantly improved.

Preferably, the trinitrile compound is selected from at least one of glycerol trinitrile, 1,3,6-hexanetricarbonitrile, 1,3,5-pentanetricarbonitrile, 1,2,3-propanetricarbonitrile, 1,2,6-hexane trinitrile, 1,2,3-tris(2-cyanoethoxy)propane, 1,2,4-tris(2-cyanoethoxy)butane, 1,1,1-tris(cyanoethoxymethylene) ethane, 1,1,1-tris(cyanoethoxymethylene)propane, 3-methyl-1,3,5-tris(cyanoethoxy)pentane, 1,2,7-tris(cyanoethoxy)heptane, 1,2,6-tris(cyanoethoxy)hexane, or 1,2,5-tris(cyanoethoxy)pentane. What work in the trinitrile compound are three nitrile groups. The three nitrile groups coordinate with the transition metal, so that stability of the battery is improved. In a specific embodiment of the present disclosure, the trinitrile compound is glycerol trinitrile and/or 1,3,6-hexanetricarbonitrile. However, another trinitrile compound may also play a role in coordinating with the transition metal.

Preferably, the trinitrile compound is selected from at least one of glycerol trinitrile or 1,3,6-hexanetricarbonitrile. Because glycerol trinitrile and 1,3,6-hexanetricarbonitrile are relatively more stable, high-voltage performance can be better improved.

Preferably, a content of the additive A in the electrolyte solution ranges from 0.1 wt % to 2 wt %, for example, is 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, or 2 wt %. Preferably, a content of the additive A in the electrolyte solution ranges from 0.2 wt % to 1.5 wt %. An excessively low content of the additive A leads to an unconspicuous effect; and an excessively high content of the additive A leads to a high possibility of precipitation, which affects performance of the battery.

Preferably, a content of the additive B in the electrolyte solution ranges from 0.1 wt % to 5 wt %, for example, is 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.2 wt %, 2.4 wt %, 2.5 wt %, 2.6 wt %, 2.8 wt %, 3 wt %, 3.3 wt %, 3.5 wt %, 3.8 wt %, 4 wt %, 4.2 wt %, 4.5 wt %, 4.8 wt %, or 5 wt %. In a specific embodiment provided in the present disclosure, a content of the additive B in the electrolyte solution ranges from 2 wt % to 4 wt %. An excessively low content of the additive B leads to excessively less coordination coverage with the transition metal, resulting in a poor improving effect; and an excessively high content of the additive B leads to relatively large impedance.

Preferably, the electrolyte salt is a lithium salt or a sodium salt.

In a specific embodiment provided in the present disclosure, the lithium salt is selected from at least one of lithium hexafluorophosphate (LiPF₆), lithium difluorophosphate (LiPO₂F₂), lithium difluorooxalate borate (LiDFOB), lithium bis(fluorosulfonyl)imide (LiTFSI), lithium bis(trifluoromethanesulphonyl)imide, lithium bis(oxyalyl)difluorophosphate, lithium tetrafluoroborate, lithium bisoxalate borate, lithium hexafluoroantimonate (V), lithium hexafluoroarsenate(V), lithium bis(pentafluoroethanesulfonyl)imide, lithium tris(trifluoromethylsulfonyl)methyl, or lithium bis(trifluoromethylsulfonyl)imide.

In a specific embodiment provided in the present disclosure, the sodium salt is selected from at least one of NaPF₆, NaClO₄, NaAlCl₄, NaFeCl₄, NaSO₃CF₃, NaBCl₄, NaNO₃, NaPOF₄, NaSCN, NaCN, NaAsF₆, NaCF₃CO₂, NaSbF₆, NaC₆HsCO₂, Na(CH₃)C₆H₄SO₃, NaHSO₄, or NaB(C₆H₅)₄.

Preferably, a content of the electrolyte salt in the electrolyte solution ranges from 11 wt % to 18 wt %, for example, is 11 wt %, 12 wt %, 13 wt %, 14 wt %, 15 wt %, 16 wt %, 17 wt %, or 18 wt %.

In a specific embodiment provided in the present disclosure, the organic solvent includes carbonate and/or carboxylate.

Preferably, the carbonate is selected from at least one of ethylene carbonate (EC), the following solvents, or fluorides of the following solvents: propylene carbonate (PC), dimethyl carbonate, diethyl carbonate (DEC), or ethyl methyl carbonate.

Preferably, the carboxylate is selected from at least one of the following solvents or their fluorides: propyl acetate, n-butyl acetate, isobutyl acetate, n-amyl acetate, isoamyl acetate, propyl propionate (PP), ethyl propionate (EP), methyl butyrate, or ethyl butyrate.

Preferably, the electrolyte solution further includes an additive C; and the additive C is selected from at least one of a cyclic carbonate additive, a cyclic sultone additive, or a nitrile additive.

Preferably, the cyclic carbonate additive includes at least one of fluoroethylene carbonate, vinylene carbonate, or vinyl ethylene carbonate.

In a specific embodiment provided in the present disclosure, the cyclic carbonate additive is fluoroethylene carbonate.

Preferably, the cyclic sultone additive is selected from at least one of 1,3-propane sultone, 1,3-propene sultone, 2,4-butane sultone, or 1,4-butane sultone.

In a specific embodiment provided in the present disclosure, the cyclic sultone additive is selected from at least one of 1,3-propane sultone or 1,3-propene sultone.

Preferably, the nitrile additive is selected from at least one of succinonitrile, adiponitrile, glutaronitrile, 1,5-dicyanopentane, 1,6-dicyanohexane, 1,7-dicyanoheptane, 1,8-dicyanatooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 1,4-dicyanopentane, 2,6-dicyanoheptane, 2,7-dicyanatooctane, 2,8-dicyanononane, 1,6-dicyanodecane, 1,2-dicyanobenzene, 1,3-dicyanobenzene, 1,4-dicyanobenzene, 3,5-dioxapimelonitrile, 1,4-bis(cyanoethoxy)butane, ethylene glycol bis(2-cyanoethyl) ether, diethylene glycol bis(2-cyanoethyl) ether, triethylene glycol bis(2-cyanoethyl) ether, tetraethylene glycol bis (2-cyanoethyl) ether, 3,6,9,12,15,18-hexaoxeicosanic acid dinitrile, 1,3-bis(2-cyanoethoxy)propane, 1,4-bis(2-cyanoethoxy)butane, 1,5-bis(2-cyanoethoxy)pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, or 1,6-dicyano-2-methyl-5-methyl-3-hexene.

In a specific embodiment provided in the present disclosure, the nitrile additive is selected from at least one of succinonitrile or adiponitrile.

Preferably, a content of the additive C in the electrolyte solution is less than or equal to 15 wt %, for example, is 0.001 wt %, 0.005 wt %, 0.01 wt %, 0.05 wt %, 0.1 wt %, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %.

The present disclosure further provides a battery. The battery includes the foregoing electrolyte solution.

The battery includes a lithium-ion battery and/or a sodium-ion battery.

In a specific embodiment provided in the present disclosure, the battery further includes a positive electrode plate, a negative electrode plate, and a separator.

Preferably, the battery is a lithium-ion battery.

Preferably, the battery is a high-voltage battery. In a specific embodiment provided in the present disclosure, a charge cut-off voltage of the battery is 4.48 V or above, for example, is 4.5 V or 4.53 V. In a specific embodiment provided in the present disclosure, a charge cut-off voltage of the battery is 4.5 V or above. For example, the battery is a high-voltage lithium cobalt oxide battery, a high-voltage ternary battery, or a high-voltage lithium-rich manganese-based battery.

More preferably, the battery is a high-voltage lithium cobalt oxide battery.

In a specific embodiment provided in the present disclosure, the positive electrode plate includes a positive electrode current collector and a positive electrode active material layer coated on at least one side surface of the positive electrode current collector. The positive electrode active material layer includes a positive electrode active material, a positive electrode conductive agent, and a positive electrode binder.

In a specific embodiment provided in the present disclosure, the positive electrode active material layer includes the following components by mass percentage: 80 wt % to 99.8 wt % (for example, 80 wt %, 82 wt %, 84 wt %, 86 wt %, 88 wt %, 90 wt %, 92 wt %, 94 wt %, 96 wt %, 98 wt %, 99 wt %, or 99.8 wt %) of the positive electrode active material, 0.1 wt % to 10 wt % (for example, 10 wt %, 9 wt %, 8 wt %, 7 wt %, 6 wt %, 5 wt %, 4 wt %, 3 wt %, 2 wt %, 1 wt %, 0.5 wt %, or 0.1 wt %) of the positive electrode conductive agent, and 0.1 wt % to 10 wt % (for example, 10 wt %, 9 wt %, 8 wt %, 7 wt %, 6 wt %, 5 wt %, 4 wt %, 3 wt %, 2 wt %, 1 wt %, 0.5 wt %, or 0.1 wt %) of the positive electrode binder.

Preferably, the positive electrode active material layer includes the following components by mass percentage: 90 wt % to 99.6 wt % of the positive electrode active material, 0.2 wt % to 5 wt % of the positive electrode conductive agent, and 0.2 wt % to 5 wt % of the positive electrode binder.

In a specific embodiment provided in the present disclosure, the negative electrode plate includes a negative electrode current collector and a negative electrode active material layer coated on at least one side surface of the negative electrode current collector. The negative electrode active material layer includes a negative electrode active material, a negative electrode conductive agent, and a negative electrode binder.

In a specific embodiment provided in the present disclosure, the negative electrode active material layer includes the following components by mass percentage: 80 wt % to 99.8 wt % (for example, 80 wt %, 82 wt %, 84 wt %, 86 wt %, 88 wt %, 90 wt %, 92 wt %, 94 wt %, 96 wt %, 98 wt %, 99 wt %, or 99.8 wt %) of the negative electrode active material, 0.1 wt % to 10 wt % (for example, 10 wt %, 9 wt %, 8 wt %, 7 wt %, 6 wt %, 5 wt %, 4 wt %, 3 wt %, 2 wt %, 1 wt %, 0.5 wt %, or 0.1 wt %) of the negative electrode conductive agent, and 0.1 wt % to 10 wt % (for example, 10 wt %, 9 wt %, 8 wt %, 7 wt %, 6 wt %, 5 wt %, 4 wt %, 3 wt %, 2 wt %, 1 wt %, 0.5 wt %, or 0.1 wt %) of the negative electrode binder.

Preferably, the negative electrode active material layer includes the following components by mass percentage: 90 wt % to 99.6 wt % of the negative electrode active material, 0.2 wt % to 5 wt % of the negative electrode conductive agent, and 0.2 wt % to 5 wt % of the negative electrode binder.

In a specific embodiment provided in the present disclosure, the positive electrode conductive agent and the negative electrode conductive agent are each independently selected from at least one of conductive carbon black, acetylene black, Ketjen black, conductive graphite, carbon nanotube, metal powder, or carbon fiber. The carbon fiber includes, for example, conductive carbon fiber.

In a specific embodiment provided in the present disclosure, the positive electrode binder and the negative electrode binder are each independently selected from at least one of sodium carboxymethyl cellulose, styrene-butadiene rubber, polytetrafluoroethylene, or polyethylene oxide.

In a specific embodiment provided in the present disclosure, the positive electrode active material is selected from at least one of a transition metal lithium oxide, a lithium iron phosphate, or a lithium-rich manganese-based material. A chemical formula of the transition metal lithium oxide is Li₁₊ₓNi_{y}Co_{z}M_{(1-y-z)}O₂, where −0.1≤x≤1; 0≤y≤1; 0≤z≤1; 0≤y+z≤1; and M is at least one of Mg, Zn, Ga, Ba, Al, Fe, Cr, Sn, V, Mn, Sc, Ti, Nb, Mo, or Zr.

In a specific embodiment provided in the present disclosure, the negative electrode active material includes a carbon-based negative electrode material.

In a specific embodiment provided in the present disclosure, the carbon-based negative electrode material includes at least one of artificial graphite, natural graphite, mesocarbon microbead, hard carbon, or soft carbon.

In a specific embodiment provided in the present disclosure, the negative electrode active material may further include a silicon-based negative electrode material.

In a specific embodiment provided in the present disclosure, the silicon-based negative electrode material is selected from at least one of nano silicon, a silicon-oxygen negative electrode material (SiOₓ (0<x<2)), or a silicon-carbon negative electrode material.

In a specific embodiment provided in the present disclosure, a mass ratio of the carbon-based negative electrode material to the silicon-based negative electrode material in the negative electrode active material ranges from 10:0 to 1:19, for example, is 1:19, 1:18, 1:17, 1:16, 1:15, 1:14, 1:13, 1:12, 1:11, 1:10, 1:9, 2:8, 3:7, 4:6, 5:5, 6:4, 7:3, 8:2, 9:1, or 10:0. The mass ratio of the carbon-based negative electrode material to the silicon-based negative electrode material being 10:0 means that the negative electrode active material does not include the silicon-based negative electrode material.

In a specific embodiment provided in the present disclosure, the battery further includes outer packaging.

In a specific embodiment provided in the present disclosure, a preparation method of the battery is: stacking the positive electrode plate, the separator, and the negative electrode plate to obtain a battery cell; or stacking the positive electrode plate, the separator, and the negative electrode plate, followed by winding to obtain a battery cell; and placing the battery cell in the outer packaging, and injecting the electrolyte solution into the outer packaging to obtain the battery of the present disclosure.

In the electrolyte solution provided in the present disclosure and the battery including the electrolyte solution, a CEI film having a high strength and being rich in inorganic matter may be formed by oxidatively decomposing an additive A (a selenocyanate salt) at a positive electrode; and the additive B (the trinitrile compound) may coordinate with the transition metal. In this way, oxidative decomposition side reactions of the electrolyte solution are greatly reduced; and a loss of a positive electrode active material of the battery under a high-temperature condition is decreased. Therefore, stability of the battery is improved; and high-temperature and high-pressure performance of the battery is significantly improved. The electrolyte solution obtained by adding the additive A and the additive B is more applicable to a high-voltage battery system, thereby improving energy density of the battery. The additive C improves stability of the electrolyte solution at the negative electrode mainly by forming a film at the negative electrode, and may further enhance a protection effect on the positive electrode.

The present disclosure discloses an electrolyte solution and a battery. Those skilled in the art may appropriately improve implementation of process parameters with reference to content herein. It should be particularly noted that all similar replacements and modifications are apparent to those skilled in the art and are deemed to be included in the present disclosure. Methods and applications of the present disclosure have been described by using preferred embodiments. It is apparent to relevant personnel that the methods and applications described herein can be modified or appropriately modified and combined without departing from the content, spirit, and scope of the present disclosure.

All experimental methods used in the following examples are conventional methods, unless otherwise specified. Reagents, materials, and the like that are used in the following examples may be all commercially available unless otherwise specified.

The present disclosure is further described below with reference to examples.

### Examples 1 to 9 and 12 to 15 and Comparative Examples 1 and 2

Batteries in Examples 1 to 9 and 12 to 15 and Comparative Examples 1 and 2 were prepared according to the following steps.
1) Preparation of a Positive Electrode Plate

A positive electrode active material (lithium cobalt oxide (LiCoO₂)), polyvinylidene fluoride (PVDF), conductive carbon black (super P), single-walled carbon nanotubes (SWCNTs) were mixed at a mass ratio of 96:2:1.5:0.5; N-methylpyrrolidone (NMP) was added; stirring was performed under action of a vacuum mixer until a mixed system became a positive electrode active slurry with uniform fluidity; the positive electrode active slurry was evenly applied on two surfaces of an aluminum foil; and the coated aluminum foil was dried, followed by roll-pressing and cutting, to obtain the positive electrode plate.
2) Preparation of a Negative Electrode Plate

A negative electrode active material (artificial graphite), sodium carboxymethyl cellulose (CMC-Na), styrene-butadiene rubber, super P, and SWCNTs were mixed at a mass ratio of 96:1.5:1.5:0.95:0.05; deionized water was added; a negative electrode active slurry was obtained under action of a vacuum mixer; the negative electrode active slurry was evenly applied on two surfaces of a copper foil; and the coated copper foil was dried at room temperature, and then transferred to an 80° C. oven for drying for 10 hours, followed by cold pressing and cutting, to obtain the negative electrode plate.
3) Preparation of an Electrolyte Solution

EC, PC, DEC, and PP were evenly mixed at a mass ratio of 10:20:40:30 in an argon-filled glove box (H₂O<0.1 ppm, O₂<0.1 ppm) to obtain a mixed solvent; then, fully dried lithium hexafluorophosphate (LiPF₆) that accounted for 14.5% of a total mass of the electrolyte solution was quickly added into the mixed solvent; fluoroethylene carbonate (additive C₁), 1,3-propanesultone (additive C₂), and succinonitrile (additive C₃) that respectively accounted for 8%, 2%, and 2% of the total mass of the electrolyte solution, and the additives described in Table 1 were added after LiPF₆ was dissolved; the mixture was stirred evenly; and the electrolyte solution was obtained after passing water content and free acid tests.
4) Preparation of a Battery

The positive electrode plate prepared in step 1), a separator (polyethylene film), the negative electrode plate prepared in step 2), and another separator (polyethylene film) were stacked sequentially, followed by winding to obtain a battery cell; the battery cell was placed in outer packaging aluminum foil; and the electrolyte solution prepared in step 3) was injected into the outer packaging, followed by processes such as vacuum packaging, standing, formation, shaping, and sorting, to obtain the battery. In the present disclosure, the battery was charged and discharged in a range of 3.0 V to 4.5 V (that is, an initial voltage was 3.0 V, and a cut-off voltage was 4.5 V) and a range of 3.0 V to 4.53 V (an initial voltage was 3.0 V, and a cut-off voltage was 4.53 V).

### Example 10

A difference from Example 3 lied in that fluoroethylene carbonate, 1,3-propanesultone, and succinonitrile were not added into the electrolyte solution.

### Comparative Example 3

A difference from Example 10 lied in that the additive A was not added into the electrolyte solution.

### Example 11

A difference from Example 10 lied in that the additive B was not added into the electrolyte solution.

### Example 16

A difference from Example 3 lied in that the additive A was replaced with an equal mass of LiSeCN.

### Example 17

A difference from Example 3 lied in that the additive B was replaced with an equal mass of 1,1,1-tris(cyanoethoxymethylene)propane.

TABLE 1
Compositions of electrolyte additives in the batteries of Examples
1 to 9 and 12 to 15 and Comparative Examples 1 and 2

| | | Additive B | |
|---|---|---|---|
| | | | 1,3,6- |
| | Additive A | Glycerol | hexanetricarbonitrile |
| Group | KSeCn (wt %) | trinitrile (wt %) | (wt %) |
| Comparative | / | / | / |
| Example 1 | | | |
| Comparative | / | / | 2 |
| Example 2 | | | |
| Example 1 | 0.5 | / | / |
| Example 2 | 0.2 | / | 2 |
| Example 3 | 0.5 | / | 2 |
| Example 4 | 1 | / | 2 |
| Example 5 | 1.5 | / | 2 |
| Example 6 | 0.5 | / | 3 |
| Example 7 | 0.5 | / | 4 |
| Example 8 | 0.5 | 2 | / |
| Example 9 | 0.5 | 1 | 1 |
| Example 12 | 0.1 | / | 2 |
| Example 13 | 2 | / | 2 |
| Example 14 | 0.5 | / | 0.1 |
| Example 15 | 0.5 | / | 5 |

Note:
“/” in Table 1 indicates that such additive was not added.

### Battery Performance Test

A storage performance test at a high temperature of 60° C. and a cycling performance test at 45° C. were performed on each of the batteries obtained in the foregoing Examples and comparative examples. The test results are shown in Table 2 and Table 3.
1) Storage Performance Test at 60° C.

The batteries obtained in the foregoing Examples and Comparative Examples were charged to a cut-off voltage at a rate of 1 C at 25° C., and then left standing for 5 minutes, where a cut-off current was 0.025 C; and thicknesses of the lithium-ion batteries were tested (used as thicknesses before storage); fully charged batteries were left open-circuited for 35 days at (60±2)° C.; after being stored for 35 days, the batteries were left open-circuited for 2 hours at room temperature; thicknesses of the stored batteries were measured after cooling, and thickness expansion rates of the lithium-ion batteries were calculated according to the following formula:

Thickness expansion rate=[(Thickness after storage and cooling−Thickness before storage)/Thickness before storage]×100%.
2) Cycling Performance Test at 45° C.

The batteries obtained in the foregoing Examples and Comparative Examples were charged and discharged for cycles within a charge-discharge cut-off voltage range at a rate of 1 C at 45° C., where a cut-off current was 0.025 C; a discharge capacity of the first cycle was tested and recorded as x₂ mAh; a discharge capacity of the N^{th} cycle was tested and recorded as y₂ mAh; the capacity of the N^{th} cycle was divided by the capacity of the first cycle, to obtain a cycling capacity retention rate R₂ of the N^{th} cycle, where R₂32 y_{2/}x₂; a number of cycles was recorded when the cycling capacity retention rate R₂ fell to 80% or lower.

TABLE 2
Performance test results of the batteries of Examples
1 to 9 and 12 to 17 and Comparative Examples 1 and 2

| | Charge and discharge range | | | |
|---|---|---|---|---|
| | 3.0 V to 4.5 V | | 3.0 V to 4.53 V | |
| | Thickness | Number of cycles | | Number of cycles |
| | expansion | recorded when | Thickness | recorded when |
| | rate after | 45° C. cycling | expansion rate | 45° C. cycling |
| | storage at | capacity retention | after storage at | capacity retention |
| Group | 60° C. for 35 days | rate was 80% | 60° C. for 35 days | rate was 80% |
| Comparative | 15.8% | 321 | 18.6% | 274 |
| Example 1 | | | | |
| Comparative | 11.1% | 379 | 13.5% | 323 |
| Example 2 | | | | |
| Example 1 | 12.3% | 354 | 15.0% | 301 |
| Example 2 | 8.7% | 478 | 10.6% | 416 |
| Example 3 | 6.7% | 503 | 8.5% | 438 |
| Example 4 | 6.3% | 515 | 8.0% | 449 |
| Example 5 | 6.1% | 522 | 7.7% | 457 |
| Example 6 | 5.9% | 526 | 7.4% | 462 |
| Example 7 | 5.7% | 514 | 7.1% | 446 |
| Example 8 | 6.9% | 499 | 8.8% | 432 |
| Example 9 | 6.8% | 502 | 8.6% | 436 |
| Example 12 | 9.8% | 456 | 12.2% | 369 |
| Example 13 | 10.1% | 449 | 12.5% | 354 |
| Example 14 | 10.8% | 437 | 12.7% | 348 |
| Example 15 | 5.6% | 486 | 6.8% | 421 |
| Example 16 | 6.8% | 505 | 8.6% | 442 |
| Example 17 | 6.9% | 496 | 8.9% | 427 |

TABLE 3
Performance test results of the batteries in the
Examples 10 and 11 and Comparative Example 3

| | Charge and discharge range | | | |
|---|---|---|---|---|
| | 3.0 V to 4.5 V | | 3.0 V to 4.53 V | |
| | | Number of | | Number of |
| | Thickness | cycles | Thickness | cycles |
| | expansion | recorded when | expansion | recorded when |
| | rate after | 45° C. cycling | rate after | 45° C. cycling |
| | storage at | capacity | storage at | capacity |
| | 60° C. for | retention rate | 60° C. for | retention rate |
| Group | 35 days | was 80% | 35 days | was 80% |
| Example 10 | 12.1% | 358 | 14.6% | 309 |
| Comparative | 16.4% | 284 | 19.3% | 238 |
| Example 3 | | | | |
| Example 11 | 17.6% | 278 | 20.7% | 231 |

It may be learned from Table 2 that for the battery obtained in Comparative Example 1 in which the additive potassium selenocyanate and the trinitrile compounds were not added, its thickness expansion rate after storage at 60° C. is significantly greater than those of other groups, and its number of cycles recorded when 45° C. cycling capacity retention rate was 80% is significantly smaller than those of other groups.

For the battery obtained in Comparative Example 2 in which only the trinitrile compound was added, its thickness expansion rate is significantly greater than those of other example groups, and its number of cycles recorded when 45° C. cycling capacity retention rate was 80% is also significantly smaller than those of other example groups (except Comparative Example 1).

For the battery obtained in Example 1 in which only potassium selenocyanate was added, its thickness expansion rate after storage at 60° C. is significantly smaller than that in Comparative Example 1, and its number of cycles recorded when 45°° C. cycling capacity retention rate was 80% is also significantly greater than that in Comparative Example 1.

It may be learned from Examples 2 to 5 that when both the additive potassium selenocyanate and the trinitrile compound are added, as the addition amount of potassium selenocyanate increases, the thickness expansion rate after storage at 60°° C. for 35 days decreases slowly, but the number of cycles recorded when 45° C. cycling capacity retention rate is 80% increases quickly and then increases slowly. This is because more potassium selenocyanate leads to better protection of the positive electrode, resulting in better storage performance. However, a large amount of potassium selenocyanate leads to excessive impedance, resulting in decrease in cycling performance improvement.

It may be learned from Examples 3, 6, and 7 that when both the additive potassium selenocyanate and the trinitrile compound are added, as the addition amount of 1,3,6-hexanetricarbonitrile increases, the thickness expansion rate after storage at 60° C. for 35 days decreases gradually, but the number of cycles recorded when 45° C. cycling capacity retention rate is 80% increases first and then decreases. This is because a larger amount of the trinitrile compound leads to better protection of the positive electrode, resulting in better storage performance. However, a large amount of the trinitrile compound leads to excessive impedance, resulting in decrease in cycling performance improvement.

It may be learned from Examples 8 and 9 that using 1,3,6-hexanetricarbonitrile and using glycerol trinitrile may achieve similar effects.

It may be learned from Table 3 that in a case that the additive C is not added, after both the additive potassium selenocyanate and the trinitrile compound are added, the thickness expansion rate after storage at 60°° C. decreases significantly, but the number of cycles recorded when 45° C. cycling capacity retention rate is 80% increases significantly.

In summary, in the electrolyte solution of the present disclosure in which both the selenocyanate salt and the trinitrile compound are added, the selenocyanate salt may be oxidatively decomposed at the positive electrode to form a CEI film that has a high strength and is rich in inorganic matter, and the trinitrile compound may coordinate with the transition metal. In this way, oxidative decomposition side reactions of the electrolyte solution are greatly reduced; and a loss of a positive electrode active material of the battery under a high-temperature condition is decreased. Therefore, stability of the battery is improved; and high-temperature and high-pressure performance of the battery is significantly improved.

The foregoing descriptions are merely preferred implementations of the present disclosure. It should be noted that those of ordinary skill in the art may further make several improvements and refinements without departing from the principle of the present disclosure, and these improvements and refinements shall fall within the protection scope of the present disclosure.

What is claimed is:

1. An electrolyte solution, comprising an organic solvent, an electrolyte salt, and an additive A; wherein the additive A is a selenocyanate salt.

2. The electrolyte solution according to claim 1, wherein the selenocyanate salt is selected from at least one of potassium selenocyanate, sodium selenocyanate, or lithium selenocyanate.

3. The electrolyte solution according to claim 2, wherein the selenocyanate salt is potassium selenocyanate.

4. The electrolyte solution according to claim 1, wherein the electrolyte solution further comprises an additive B; and the additive B is a trinitrile compound.

5. The electrolyte solution according to claim 4, wherein the trinitrile compound is selected from at least one of glycerol trinitrile, 1,3,6-hexanetricarbonitrile, 1,3,5-pentanetricarbonitrile, 1,2,3-propanetricarbonitrile, 1,2,6-hexane trinitrile, 1,2,3-tris(2-cyanoethoxy)propane, 1,2,4-tris(2-cyanoethoxy)butane, 1,1,1-tris(cyanoethoxymethylene)ethane, 1,1,1-tris(cyanoethoxymethylene)propane, 3-methyl-1,3,5-tris(cyanoethoxy)pentane, 1,2,7-tris(cyanoethoxy)heptane, 1,2,6-tris(cyanoethoxy)hexane, or 1,2,5-tris(cyanoethoxy)pentane.

6. The electrolyte solution according to claim 5, wherein the trinitrile compound is selected from at least one of glycerol trinitrile or 1,3,6-hexanetricarbonitrile.

7. The electrolyte solution according to claim 1, wherein a content of the additive A in the electrolyte solution ranges from 0.1 wt % to 2 wt %.

8. The electrolyte solution according to claim 1, wherein a content of the additive A in the electrolyte solution ranges from 0.2 wt % to 1.5 wt %.

9. The electrolyte solution according to claim 4, wherein a content of the additive B in the electrolyte solution ranges from 0.1 wt % to 5 wt %.

10. The electrolyte solution according to claim 9, wherein the content of the additive B in the electrolyte solution ranges from 2 wt % to 4 wt %.

11. The electrolyte solution according to claim 1, wherein the electrolyte salt is a lithium salt or a sodium salt.

12. The electrolyte solution according to claim 11, wherein the lithium salt is selected from at least one of lithium hexafluorophosphate, lithium difluorophosphate, lithium difluorooxalate borate, lithium bis(fluorosulfonyl)imide, lithium bis(trifluoromethanesulphonyl)imide, lithium bis(oxyalyl)difluorophosphate, lithium tetrafluoroborate, lithium bisoxalate borate, lithium hexafluoroantimonate(V), lithium hexafluoroarsenate(V), lithium bis(pentafluoroethanesulfonyl)imide, lithium tris(trifluoromethylsulfonyl)methyl, or lithium bis(trifluoromethylsulfonyl)imide; and/or
the sodium salt is selected from at least one of NaPF₆, NaClO₄, NaAlCl₄, NaFeCl₄, NaSO₃CF₃, NaBCl₄, NaNO₃, NaPOF₄, NaSCN, NaCN, NaAsF₆, NaCF₃CO₂, NaSbF₆, NaC₆H₅CO₂, Na(CH₃)C₆H₄SO₃, NaHSO₄, or NaB(C₆H₅)₄.

13. The electrolyte solution according to claim 1, wherein a content of the electrolyte salt in the electrolyte solution ranges from 11 wt % to 18 wt %.

14. The electrolyte solution according to claim 1, wherein the organic solvent comprises carbonate and/or carboxylate.

15. The electrolyte solution according to claim 14, wherein the carbonate is selected from at least one of ethylene carbonate, following solvents, or fluorides of the following solvents: propylene carbonate, dimethyl carbonate, diethyl carbonate, or ethyl methyl carbonate; and/or
the carboxylate is selected from at least one of following solvents or their fluorides: propyl acetate, n-butyl acetate, isobutyl acetate, n-amyl acetate, isoamyl acetate, propyl propionate, ethyl propionate, methyl butyrate, or ethyl butyrate.

16. The electrolyte solution according to claim 1, wherein the electrolyte solution further comprises an additive C; and the additive C is selected from at least one of a cyclic carbonate additive, a cyclic sultone additive, or a nitrile additive.

17. The electrolyte solution according to claim 16, wherein a content of the additive C in the electrolyte solution is less than or equal to 15 wt %; and/or
the cyclic carbonate additive comprises at least one of fluoroethylene carbonate, vinylene carbonate, or vinyl ethylene carbonate; and/or
the cyclic sultone additive is selected from at least one of 1,3-propane sultone, 1,3-propene sultone, 2,4-butane sultone, or 1,4-butane sultone; and/or
the nitrile additive is selected from at least one of succinonitrile, adiponitrile, glutaronitrile, 1,5-dicyanopentane, 1,6-dicyanohexane, 1,7-dicyanoheptane, 1,8-dicyanatooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 1,4-dicyanopentane, 2,6-dicyanoheptane, 2,7-dicyanatooctane, 2,8-dicyanononane, 1,6-dicyanodecane, 1,2-dicyanobenzene, 1,3-dicyanobenzene, 1,4-dicyanobenzene, 3,5-dioxapimelonitrile, 1,4-bis(cyanoethoxy)butane, ethylene glycol bis(2-cyanoethyl) ether, diethylene glycol bis(2-cyanoethyl) ether, triethylene glycol bis(2-cyanoethyl) ether, tetraethylene glycol bis(2-cyanoethyl) ether, 3,6,9,12,15,18-hexaoxeicosanic acid dinitrile, 1,3-bis(2-cyanoethoxy)propane, 1,4-bis(2-cyanoethoxy)butane, 1,5-bis(2-cyanoethoxy)pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, or 1,6-dicyano-2-methyl-5-methyl-3-hexene.

18. A battery, comprising the electrolyte solution according to claim 1.

19. The battery according to claim 18, wherein the battery further comprises a positive electrode plate, a negative electrode plate, and a separator; and/or
the battery comprises a lithium-ion battery and/or a sodium-ion battery; and/or
the battery is a high-voltage battery; and/or
a charge cut-off voltage of the battery is 4.48 V or above; and/or
the battery is a high-voltage lithium cobalt oxide battery, a high-voltage ternary battery, or a high-voltage lithium-rich manganese-based battery.

20. The battery according to claim 19, wherein the battery is a lithium-ion battery; and/or
a charge cut-off voltage of the battery is 4.5 V or above; and/or
the battery is a high-voltage lithium cobalt oxide battery.
